(19) United States
(12) Patent Application Publication
(10) Pub. No.: US 2024/0168790 A1
(43) Pub. Date: May 23, 2024

(54) SYSTEM AND METHOD FOR RECOMMENDING GUIDELINES FOR MANAGED OBJECTS IN A CLOUD ENVIRONMENT

(71) Applicant: VMWARE, INC., Palo Alto, CA (US)

(72) Inventors: VAMSHIK SHETTY, Bangalore (IN); Maarten Wiggers, San Francisco, CA (US); Jobin George, Bangalore (IN)

(21) Appl. No.: 18/097,526

(22) Filed: Jan. 17, 2023

(30) Foreign Application Priority Data
Nov. 23, 2022 (IN) 202241067258

(51) Int. Cl. G06F 9/455

(52) U.S. Cl. CPC G06F 9/45558; G06F 2009/4557

(57) ABSTRACT

System and computer-implemented method for recommending guidelines for managed objects for a computing environment uses a transductive embedding technique on a graph of the computing environment to generate initial embeddings for the nodes of the graph. An inductive embedding technique is then applied on the initial embeddings and features of the nodes of the graph to produce final embeddings for the nodes of the graph, which are used to execute a link classification operation on the final embeddings for at least some nodes of the graph to select a recommended guideline for a target managed object.

### RELATED APPLICATIONS

Benefit is claimed under 35 U.S.C. 119(a)-(d) to Foreign Application Serial No. 202241067258 filed in India entitled “SYSTEM AND METHOD FOR RECOMMENDING GUIDELINES FOR MANAGED OBJECTS IN A CLOUD ENVIRONMENT”, on Nov. 23, 2022, by VMware, Inc., which is herein incorporated in its entirety by reference for all purposes.

### BACKGROUND

Software-defined data center (SDDC) is an architectural approach based on virtualization and automation, which drives many of current leading data centers. In an SDDC, the infrastructure is virtualized, and the control of the SDDC is entirely automated by software. In a computing environment, such as a private, public or multiple (e.g., hybrid) cloud environment, with one or more SDDCs, there is a need to establish a fluid data plane where a multitude of managed objects interact with each other in a variety of ways. These interactions are not only limited to how the managed objects behave with each other based on their intrinsic nature, but also based on external guidelines applied onto these objects by infrastructure administrators and developers. These guidelines may be produced either in the form of policies covering domains, such as workload compute, storage and networking, or in the form of direct labelling tools, such as inventory tags or fault domains.

Once such policies or tags are created, admins manually assign these guidelines or labels to managed objects as they see fit. This form of tooling works out well when the variety and number of such guidelines are limited, which is usually the case in small-scale independent setups. But as the scale of the setups becomes larger, there is exponential increase in global guidelines being generated by human operators, who interact with these managed objects on multiple fronts via a connected management plane. Overtime, in a large-scale cloud setup, as the sheer size and variety of such guidelines or labels keep on increasing, it becomes overwhelming for human operators to find a suitable guideline or to come to the conclusion that such a guideline does not exist and needs to be created.

### SUMMARY

System and computer-implemented method for recommending guidelines for managed objects for a computing environment uses a transductive embedding technique on a graph of the computing environment to generate initial embeddings for the nodes of the graph. An inductive embedding technique is then applied on the initial embeddings and features of the nodes of the graph to produce final embeddings for the nodes of the graph, which are used to execute a link classification operation on the final embeddings for at least some nodes of the graph to select a recommended guideline for a target managed object.

A computer-implemented method for recommending guidelines for managed objects for a computing environment in accordance with an embodiment of the invention comprises generating a graph of the computing environment, the graph including nodes representing managed objects in the computing environment and guideline objects associated the managed objects; applying a transductive embedding technique on the graph to generate initial embeddings for the nodes of the graph; applying an inductive embedding technique on the initial embeddings and features of the nodes of the graph to produce final embeddings for the nodes of the graph; executing a link classification operation on the final embeddings for at least some nodes of the graph to select a recommended guideline for a target managed object; and displaying the recommended guideline for the target managed object. In some embodiments, the steps of this method are performed when program instructions contained in a computer-readable storage medium are executed by one or more processors.

A system in accordance with an embodiment of the invention comprises memory and at least one processor configured to generate a graph of a computing environment, the graph including nodes representing managed objects in the computing environment and guideline objects associated the managed objects; apply a transductive embedding technique on the graph to generate initial embeddings for the nodes of the graph; apply an inductive embedding technique on the initial embeddings and features of the nodes of the graph to produce final embeddings for the nodes of the graph; execute a link classification operation on the final embeddings for at least some nodes of the graph to select a recommended guideline for a target managed object; and display the recommended guideline for the target managed object.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a guideline recommendation system for a computing environment in accordance with an embodiment of the invention.

FIG. 2 is a diagram of a software-defined data center (SDDC) that can be deployed in the computing environment in accordance with an embodiment of the invention.

FIG. 3 shows an ecosystem graph of the computing environment in accordance with an embodiment of the invention.

FIG. 4 shows components of the guideline recommendation system in accordance with an embodiment of the invention

FIG. 5 is a process flow diagram of an embedding generating operation performed by the guideline recommendation system on the computing environment in accordance with an embodiment of the invention.

FIG. 6 is a process flow diagram of a guideline recommendation operation for an existing managed object in the computing environment performed by the guideline recommendation system in accordance with an embodiment of the invention.

FIG. 7 is a process flow diagram of a guideline recommendation operation for a new managed object being added to the computing environment performed by the guideline recommendation system in accordance with an embodiment of the invention.

FIG. 8 is a flow diagram of a computer-implemented method for recommending guidelines for managed objects for a computing environment in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

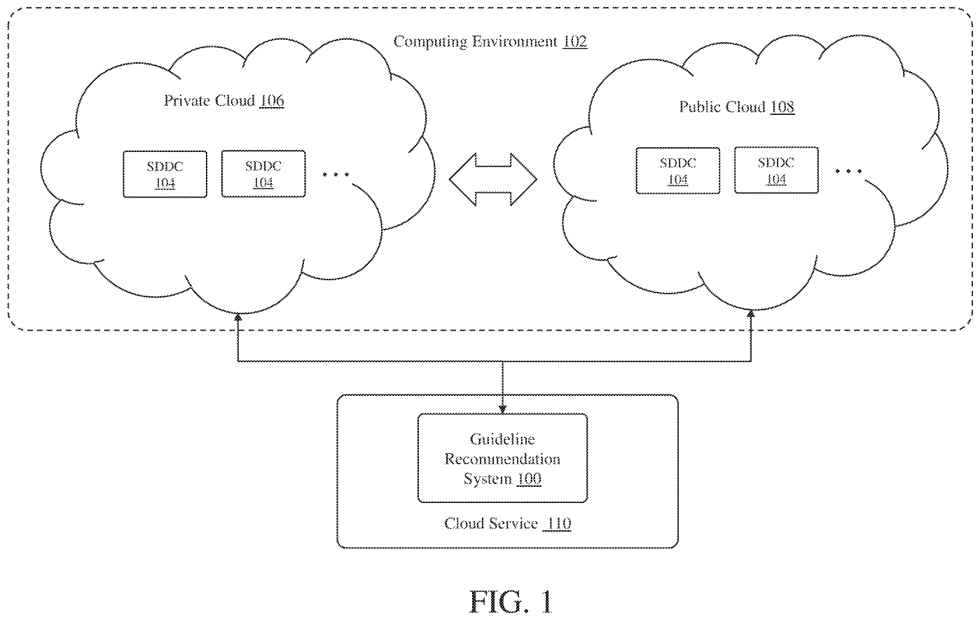

Turning now to FIG. 1, a guideline recommendation system 100 in accordance with an embodiment of the invention is illustrated. As described in more detail below, the guideline recommendation system 100 uses a graph of managed objects and guidelines in a computing environment 102 to generate transductive embeddings for nodes of the graph, which are then used with features of the graph nodes to generate inductive embeddings for the graph nodes to supplement the transductive embeddings in order to produce final embeddings for the graph nodes. As used herein, embeddings are float vectors of pre-defined length which act as a unique fingerprint of the node in graph populace. In this context, the embeddings are a culmination of trying to uniquely capture the intrinsic nature of the nodes in a graph (i.e., via inductive embeddings) while also highlighting structural placement of the nodes with respect to all the other nodes in the graph (i.e., via transductive embeddings). The final embeddings for the graph nodes are then used to train a link classification model so that guideline recommendations can be made for new and existing managed objects of the computing environment.

The computing environment 102 can be any type of a computing environment, such as an on-premises private cloud, a public cloud, or a multi-cloud environment, such as a hybrid cloud. In an embodiment, the computing environment 102 includes one or more SDDCs 104 deployed in one or more clouds in the computing environment 102. In the illustrated embodiment, the computing environment 102 includes at least one private cloud 106 and a public cloud 108. At least some of the SDDCs 104 in the computing environment 102, such as the SDDCs in the public cloud 108, may be offered by a cloud service provider as managed SDDCs. These managed SDDCs may be supported and managed by a cloud service 110, which includes various management and monitoring components to ensure that the managed SDDCs are running properly. In the illustrated embodiment, the guideline recommendation system 100 may be part of the cloud service 110.

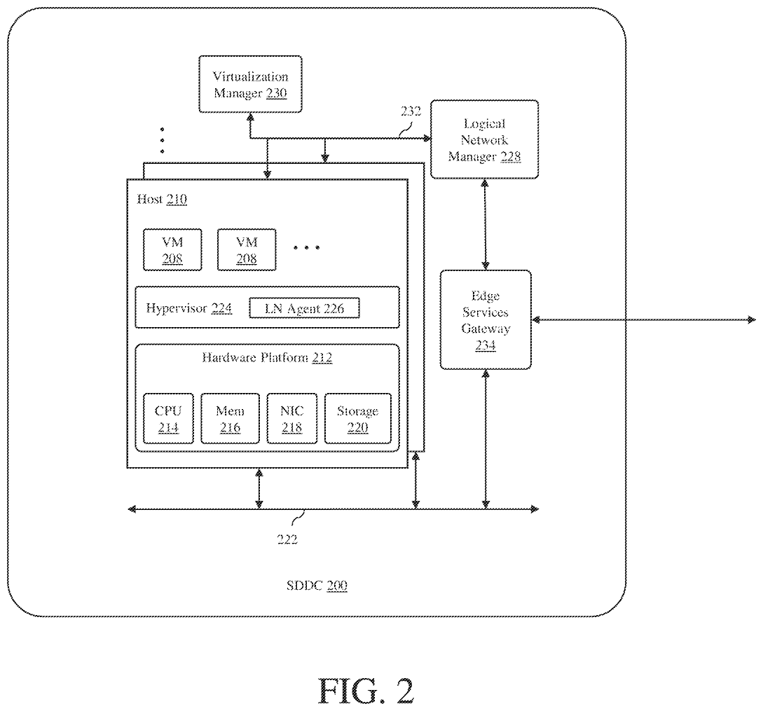

Turning now to FIG. 2, a representative SDDC 200 that can be deployed in the computing environment 102 in accordance with an embodiment of the invention is illustrated. Thus, the SDDC 200 is an example of the SDDCs 104 shown in FIG. 1.

As shown in FIG. 2, the SDDC 200 includes one or more host computer systems (“hosts”) 210. The hosts may be constructed on a server grade hardware platform 212, such as an x86 architecture platform. As shown, the hardware platform of each host may include conventional components of a computing device, such as one or more processors (e.g., CPUs) 214, system memory 216, a network interface 218, and storage 220. The processor 214 can be any type of a processor commonly used in servers. The memory 216 is volatile memory used for retrieving programs and processing data. The memory 216 may include, for example, one or more random access memory (RAM) modules. The network interface 218 enables the host 210 to communicate with other devices that are inside or outside of the SDDC 200 via a communication medium, such as a network 222. The network interface 218 may be one or more network adapters, also referred to as network interface cards (NICs). The storage 220 represents one or more local storage devices (e.g., one or more hard disks, flash memory modules, solid state disks and/or optical disks), which may be used to form a virtual storage area network (SAN).

Each host 210 may be configured to provide a virtualization layer that abstracts processor, memory, storage and networking resources of the hardware platform 212 into virtual computing instances 208, e.g., virtual machines, that run concurrently on the same host. The virtual machines run on top of a software interface layer, which is referred to herein as a hypervisor 224, that enables sharing of the hardware resources of the host by the virtual machines. One example of the hypervisor 224 that may be used in an embodiment described herein is a VMware ESXi™ hypervisor provided as part of the VMware vSphere® solution made commercially available from VMware, Inc. The hypervisor 224 may run on top of the operating system of the host or directly on hardware components of the host. For other types of virtual computing instances, the host may include other virtualization software platforms to support those virtual computing instances, such as Docker virtualization platform to support “containers.” In the following description, the virtual computing instances 208 will be described as being virtual machines.

In the illustrated embodiment, the hypervisor 224 includes a logical network (LN) agent 226, which operates to provide logical networking capabilities, also referred to as “software-defined networking” (SDN). Each logical network may include software managed and implemented network services, such as bridging, L3 routing, L2 switching, network address translation (NAT), and firewall capabilities, to support one or more logical overlay networks in the SDDC 200. The logical network agent 226 receives configuration information from a logical network manager 228 (which may include a control plane cluster) and, based on this information, populates forwarding, firewall and/or other action tables for dropping or directing packets between the virtual machines 208 in the host 210, other virtual machines on other hosts, and/or other devices outside of the SDDC 200. Collectively, the logical network agent 226, together with other logical network agents on other hosts, according to their forwarding/routing tables, implement isolated overlay networks that can connect arbitrarily selected virtual machines with each other. Each virtual machine may be arbitrarily assigned a particular logical network in a manner that decouples the overlay network topology from the underlying physical network. Generally, this is achieved by encapsulating packets at a source host and decapsulating packets at a destination host so that virtual machines on the source and destination can communicate without regard to underlying physical network topology. In a particular implementation, the logical network agent 226 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols such as stateless transport tunneling (STT), Network Virtualization using Generic Routing Encapsulation (NVGRE), or Geneve, instead of, or in addition to, VXLAN.

The SDDC 200 also includes a virtualization manager 230 that communicates with the hosts 210 via a management network 232. In an embodiment, the virtualization manager 230 is a computer program that resides and executes in a computer system, such as one of the hosts, or in a virtual computing instance, such as one of the virtual machines 208 running on the hosts. One example of the virtualization manager 230 is the VMware vCenter Server® product made available from VMware, Inc. In an embodiment, the virtualization manager is configured to carry out administrative tasks for a cluster of hosts that forms an SDDC, including managing the hosts in the cluster, managing the virtual machines running within each host in the cluster, provisioning virtual machines, migrating virtual machines from one host to another host, and load balancing between the hosts in the cluster.

As noted above, the SDDC 200 also includes the logical network manager 228 (which may include a control plane cluster), which operates with the logical network agents 226 in the hosts 210 to manage and control logical overlay networks in the SDDC 200. Logical overlay networks comprise logical network devices and connections that are mapped to physical networking resources, e.g., switches and routers, in a manner analogous to the manner in which other physical resources as compute and storage are virtualized. In an embodiment, the logical network manager 228 has access to information regarding physical components and logical overlay network components in the SDDC. With the physical and logical overlay network information, the logical network manager 228 is able to map logical network configurations to the physical network components that convey, route, and filter physical traffic in the SDDC 200. In one particular implementation, the logical network manager 228 is a VMware NSX® product running on any computer, such as one of the hosts or a virtual machine in the SDDC 200.

The SDDC 200 also includes a gateway 234 to control network traffic into and out of the SDDC 200. In an embodiment, the gateway 234 may be implemented in one of the virtual machines 208 running in the SDDC 200. In a particular implementation, the gateway 234 may be an edge services gateway. One example of the edge services gateway 234 is VMware NSX® Edge™ product made available from VMware, Inc.

Turning back to FIG. 1, the guideline recommendation system 100 uses a graph of components of the computing environment as a starting point for its operation. This graph of components of the computing environment illustrates the ecosystem of the computing environment, which includes managed objects, such as data centers, host clusters, hosts, virtual machines, folders and virtual machine templates, and guideline objects, such as tags, tag categories and policies.

In an embodiment, the managed objects for which the guideline recommendation system 100 generate recommendations are not homogenous in nature and neither are they completely independent, i.e., the managed objects can be associated to each other in following ways:
1. Relation based on physical placement of managed objects from the viewpoint of functionality. Examples of such relations include a) virtual machine residing on a host, and b) a set of hosts being part of a cluster; and
2. Relation based on inventory placement, from the viewpoint of infrastructure administrators and development and IT operations engineers. An example for such a scenario is a virtual machine being placed inside a folder based on some logical understanding of a human operator.
   These intrinsic relations exist as soon as a managed object is created and captures behaviors which are relevant from object-to-object similarity perspective and how human operators associate the said managed objects from structural point of view.

In an embodiment, tag is a metadata that can be assigned to managed objects present in the computing environment inventory, so their behavior can be subjected to control, i.e., by automated systems which leverage these attached metadata or labels to lookup needed managed objects/entities. Tag is created under a namespace of category, which allows human operators to create and group multiple labels/tags under it. Category can control the kind of inventory objects the tags can be attached to by setting property called associable type. Category can also specify whether a single or multiple tags from it can be applied to the same object at the same time using a property called cardinality.

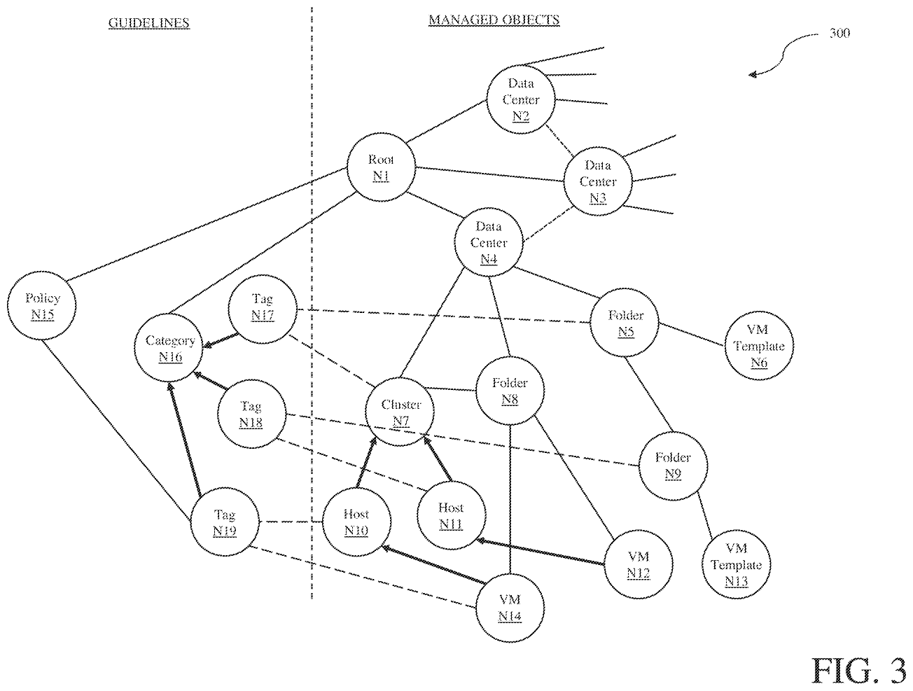

Using the managed and guideline objects, the state of an entire ecosystem of the computing environment 102 can be captured to form a heterogeneous ecosystem graph where nodes consist of both managed objects and guideline objects, e.g., tags and policies. An example of an ecosystem graph 300 of the computing environment 102 is illustrated in FIG. 3.

As shown in FIG. 3, the ecosystem graph 300 includes a root node N1, which is the root of all the nodes in the graph. The ecosystem graph 300 also includes nodes N2-N19 of managed objects and guidelines, which are connected or linked to each other by edges. In the illustrated ecosystem graph 300, the managed object nodes N2-N14 and the guideline nodes N15-N19 are graphically separated so that the different nodes are readily distinguishable. The managed objects of the nodes N2-N14 include data centers, host clusters, hosts, virtual machines (VMs), folders and VM templates. The guideline objects of the nodes N15-N19 include tags, a tag category and a policy, which may be a policy enforced via tag.

With an ecosystem graph, such as the ecosystem graph 300 of FIG. 3, the connections between the nodes can be easily visualized. Features or embeddings can be added to the nodes by the guideline recommendation system 100. As described in more detail below, both transductive and inductive embedding techniques are used by the guideline recommendation system 100 to add embeddings to the nodes of the ecosystem graph so that a link classification methodology can be used to recommend one or more guidelines to an existing node of the computing environment 102 or to a new node being added to the computing environment.

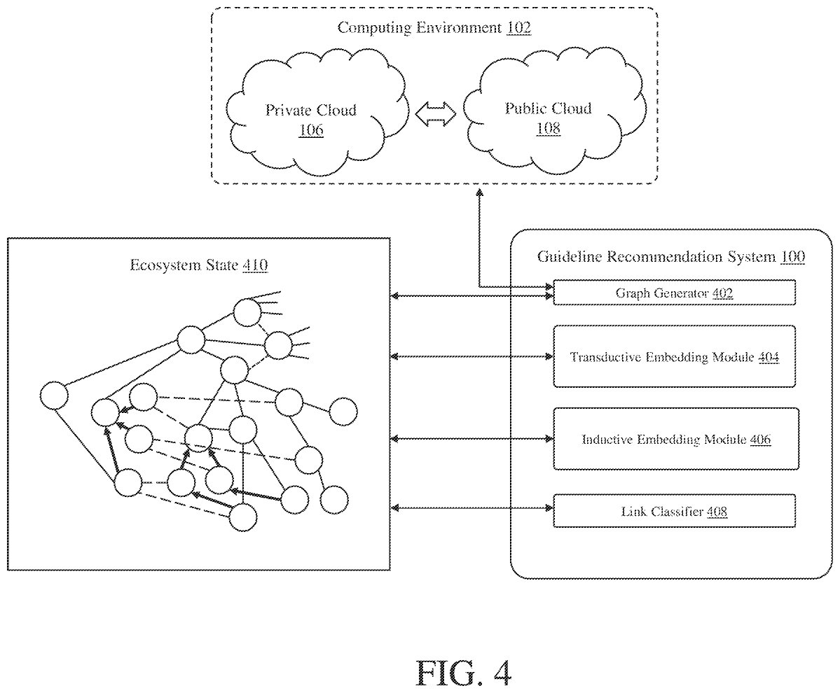

In FIG. 4, the components of the guideline recommendation system 100 in accordance with an embodiment of the invention are illustrated. As shown in FIG. 4, the guideline recommendation system 100 includes a graph generator 402, a transductive embedding module 404, an inductive embedding module 406, and a link classifier 408. In an embodiment, these components of the guideline recommendation system 100 are implemented as software running on any platform.

The graph generator 402 of the guideline recommendation system 100 operates to generate an ecosystem graph, such as the ecosystem graph 300, of the computing environment 102 from the current ecosystem state 410 of the computing environment 102. In an embodiment, the graph generator 402 maintains the dynamic state of the computing environment 102 to provide the current ecosystem graph. The graph generator 402 may leverage one or more existing tools in the computing environment 102 or in the cloud service 110 to perform an ecosystem state aggregation to maintain the dynamic state of the computing environment 102. As an example, the graph generator 402 may leverage the virtualization manager 230 in the SDDCs 104 of the computing environment 102, which may provide information regarding managed objects, tags and policies to account for changes, such as managed object creation or deletion and tag/guideline association to these managed objects, via Application Programming Interfaces (APIs).

The transductive embedding module 404 of the guideline recommendation system 100 operates to process the ecosystem graph generated by the graph generator 402 to produce vectorized context such that managed objects or guideline objects that are close to each other will produce transductive embeddings which are also closer in Hilbert space irrespective of their type. As an example, the transductive embedding module 404 may utilize the node2vec algorithm to produce the transductive embeddings. In an embodiment, the transductive embedding module 404 may be trained using machine learning with training dataset of graphs and transductive embeddings of the graph nodes so that the trained transductive embedding module can be used to produce transductive embeddings of nodes for a given ecosystem graph.

When using a transductive embedding algorithm, such as the node2vec algorithm, if the graph is disconnected, then the embeddings in one component will not have any meaningful relation with the embeddings present in another disconnected component. This is because no related sequence will be generated and all the disconnected components will be mapped to different Hilbert space. But such a scenario does not exist in the case of an ecosystem graph, such as the ecosystem graph 300, as every node is connected to the root node by some path. Generating recommendation solely depending on context embeddings generated by a transductive embedding algorithm is not enough as it ignores the intrinsic nature of all nodes whether they are managed objects or guideline objects. This loss of information is common in algorithms which are transductive, i.e., which infer embedding solely based on the observed nature of the graph via connections, and thus, these algorithms do not scale well to new types of nodes. The inductive embedding module 406 is used to overcome this issue.

The inductive embedding module 406 of the guideline recommendation system 100 operates to generate additional embeddings for the graph nodes via an inductive technique, which leverages node attribute information to generate embeddings on previously unseen data. The node attribute information can include any parameter that can be quantized. In the case of a virtualized environment, node's attributes may include, but not limited to, (1) type of node, e.g., VM, host or tag represented as one hot vector, (2) parameter to indicate if the node can use/own compute, i.e., VM and host can use/own compute, whereas folder and tag are either abstract concept or a metadata which cannot use/own compute, and (3) parameter to indicate if the node has networking functionality or other functionalities. Parameters can be generated using any common behavioral nature which can be quantized. The selection of these attributes is left to the use-case or user analysis based on domain. In an embodiment, the inductive embedding module 406 may be trained using machine learning with training dataset of transductive embeddings of graph nodes and the features of the graph nodes so that the trained inductive embedding module can be used to produce inductive embeddings of nodes for a given ecosystem graph with transductive embeddings and intrinsic node features. The training may be supervised training.

An example of an inductive embedding technique that can be utilized by the inductive embedding module 406 is the GraphSAGE algorithm, which consumes provided node features and uses features of K level of neighborhood to sample and aggregates feature information of neighboring nodes, where K defines the size of the neighboring nodes. These features are used to learn a function that generates embeddings via some tasks oriented towards supervised training. Supervised training problem statement is usually designed to force nodes connected to each to have similar representations.

Each node in the ecosystem graph of the computing environment 102 in generic terms may only be represented as one hot-encoded vector to highlight the type of that node. Other than that, there are not many other features to leverage for inductive training. Hence, the features generated by the node2vec algorithm to vector form may be concatenated to leverage transductive features in combination with node type to produce inductive embeddings which not only captures varied types of nodes but also their observed connections.

The link classifier 408 of the guideline recommendation system 100 operates to provide guideline recommendation for new managed objects being added to the computing environment 102 or for existing managed objects in the computing environment 102 using the current inductive embeddings of graph nodes. In an embodiment, a computer model may be trained using machine learning with training dataset of inductive embeddings of graph nodes so that the trained model can be used to produce the guideline recommendations.

When a user requests for guideline recommendations for a new managed object or is looking to attach guidelines to an existing managed object, the embeddings of all the guidelines are consumed and link prediction scores against embeddings of managed objects are produced by the link classifier 408. These scores are passed through a filtering mechanism in the link classifier 408, which removes guidelines that cannot be associated with the managed object. The top recommendations are then presented to the user as output. In an embodiment, the recommendations may be presented to the user on a user interface, which is associated with the guideline recommendation system 100.

Link prediction between one managed object and all the guidelines is an expensive operation to perform in real time, which keeps on getting worse as the number of guidelines in the computing environment 102 keeps on increasing. In an embodiment, in order to solve this issue, before generating the link scores through a classification process, the guidelines are first filtered by performing some R number of random walks of length Lₘₐₓ while keeping the managed object at the start and only produce link prediction for guidelines which are present in these walks. The variable R and Lₘₐₓ may be selected using empirical analysis.

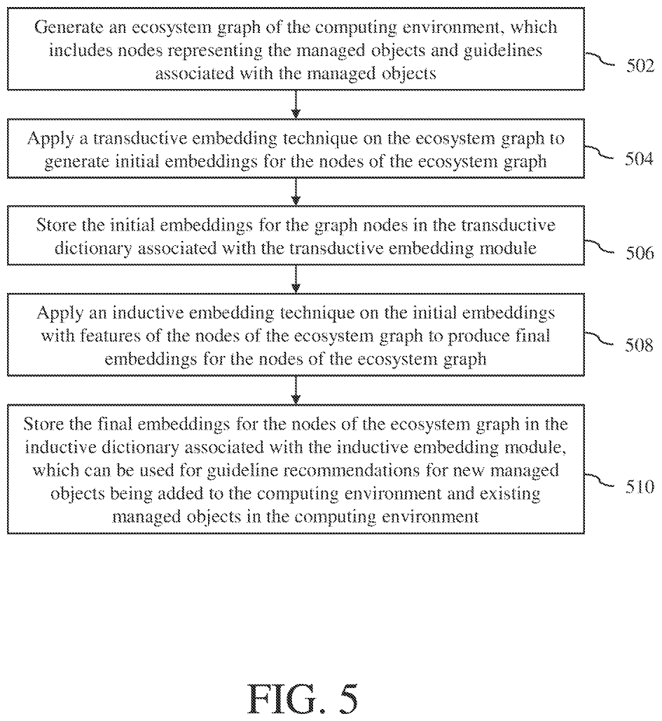

An embedding generating operation performed by the guideline recommendation system 100 on the computing environment 102 in accordance with an embodiment of the invention is described with reference to a process flow diagram shown in FIG. 5. The embedding generating operation may be executed periodically, for example, once a day or any other time interval, or in response to a command to update the embeddings from a previous embedding generating operation.

The embedding generating operation begins at step 502, where an ecosystem graph of the computing environment 102 is generated by the graph generator 402 of the guideline recommendation system 100. The generated ecosystem graph includes nodes that represent the managed objects and the guideline objects associated with the managed objects, which are connected by edges, as illustrated in FIG. 3. In an embodiment, the ecosystem graph may be generated using information from one or more tools or services running in the computing environment 102, such as virtualization managers 230.

Next, at step 504, a transductive embedding technique is applied on the ecosystem graph by the transductive embedding module 404 to generate initial embeddings for the nodes of the ecosystem graph. In an embodiment, the node2vec algorithm is used by the transductive embedding module 404 to perform the transductive embedding generation. At step 506, the initial embeddings for the nodes of the ecosystem graph are stored in a transductive dictionary associated with the transductive embedding module 404. The transductive dictionary can be any database or datastore that can be assessed by the transductive embedding module 404 to store the initial or transductive embeddings.

Next, at step 508, an inductive embedding technique is applied on the initial embeddings with features of the nodes of the ecosystem graph by the inductive embedding module 406 to generate final embeddings for the nodes of the ecosystem graph. Thus, the final embeddings for the graph nodes can be viewed as having both transductive and inductive embedding components. In an embodiment, the GraphSAGE algorithm is used by the inductive embedding module 406 to perform the inductive embedding generation. At step 510, the final embeddings for the nodes of the ecosystem graph are stored in an inductive dictionary associated with the inductive embedding module 406. Similar to the transductive dictionary, the inductive dictionary can be any database or datastore that can be assessed by the inductive embedding module 406 to store the final embeddings. The final embeddings for the nodes of the ecosystem graph can be used by the link classifier 408 to make guideline recommendations for new managed objects being added to the computing environment 102 and existing managed objects in the computing environment 102.

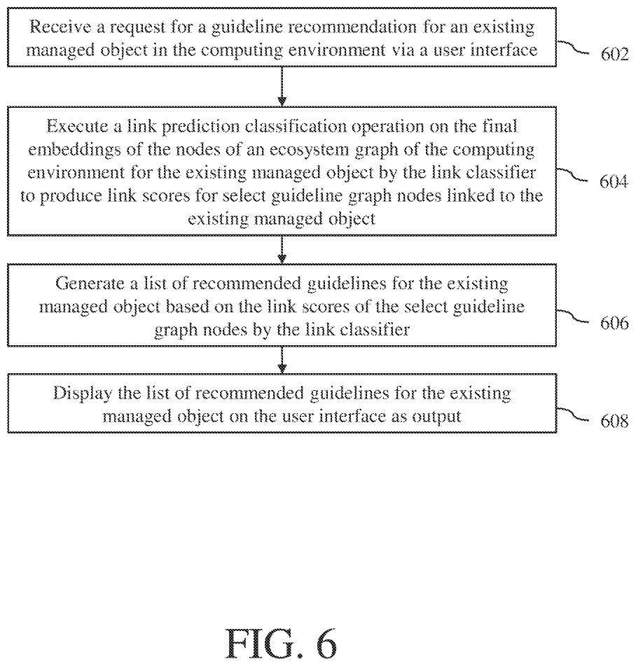

A guideline recommendation operation for an existing managed object in the computing environment 102 performed by the guideline recommendation system 100 in accordance with an embodiment of the invention is described with reference to a process flow diagram shown in FIG. 6. The guideline recommendation operation begins at step 602, where a request for a guideline recommendation for an existing managed object in the computing environment 102 is received via a user interface associated with the guideline recommendation system 100. The user interface may be a web-based user interface.

Next, at step 604, a link prediction classification operation is executed on the final embeddings of the nodes of an ecosystem graph of the computing environment 102 for the existing managed object by the link classifier 408 to produce link scores for select guideline graph nodes linked to the existing managed object. The final embeddings used are not an updated version of previously generated final embeddings that are generated in response to the request for a guideline recommendation for the existing managed object. Each link score for a guideline node corresponds to the strength of the link between the guideline node and the existing managed object node. The link prediction classification operation results in prediction of links between the graph node of the existing managed object and the select guideline graph nodes with the highest link score given or assigned to the guideline graph node with the strongest link to the existing managed object node.

Next, at step 606, a list of recommended guidelines for the existing managed object based on the link scores of the select guideline graph nodes is generated by the link classifier 408. Thus, the recommended guidelines correspond to the select guideline graph nodes. The list of recommended guidelines may be generated in a link score descending order such that the first recommended guideline is the guideline corresponding to the highest link score.

Next, at step 608, the list of recommended guidelines for the existing managed object is displayed on the user interface as output. In an embodiment, the link scores are also displayed with the recommended guidelines. Using the output, one or more of these recommended guidelines may be manually entered or otherwise associated with the existing managed object by the user, i.e., an administrator. In other embodiments, one or more of these recommended guidelines may be automatically entered or otherwise associated with the existing managed object by the guideline recommendation system 100.

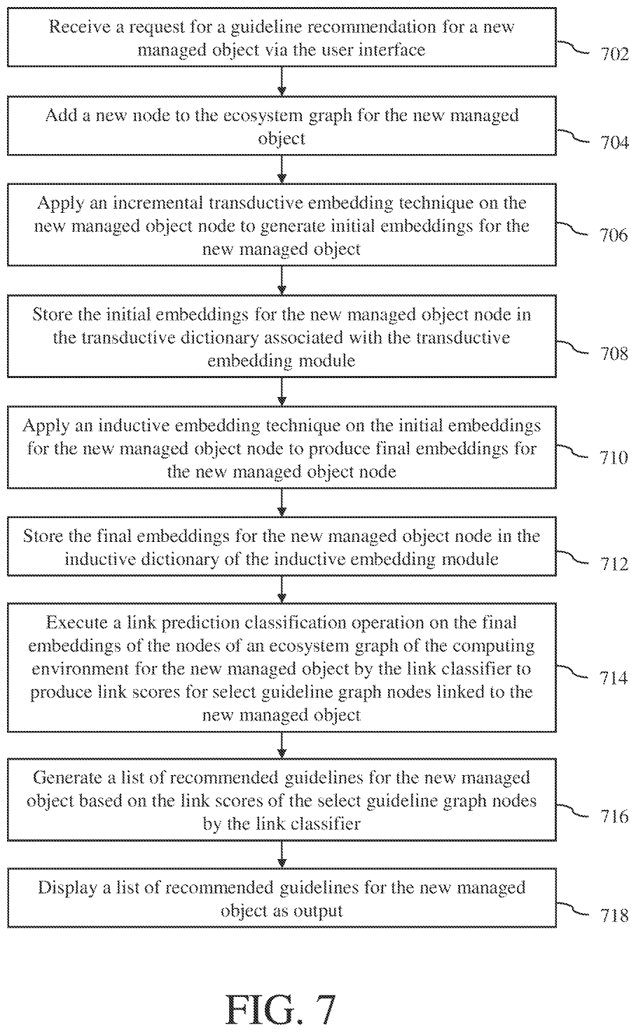

A guideline recommendation operation for a new managed object being added to the computing environment 102 in accordance with an embodiment of the invention is described with reference to a process flow diagram shown in FIG. 7. The guideline recommendation operation begins at step 702, where a request for a guideline recommendation for a new managed object being added to the computing environment 102 is received by the guideline recommendation system 100 via the associated user interface.

Next, at step 704, a node for the new managed object is added to the existing ecosystem of the computing environment 102 by the graph generator 402. Next, at step 706, an incremental transductive embedding technique is applied on the new managed object node by the transductive embedding module 404 to generate initial embeddings for the new managed object. In an embodiment, the incremental transductive embedding technique involves incrementally training via skip-gram model to capture dynamic changes due to the addition of the new managed object to the computing environment 102. As an example, the dynnode2vec algorithm may be used by the transductive embedding module 404 to perform the transductive embedding technique on the new managed object node. At step 708, the generated initial embeddings for the new managed object node are stored in the transductive dictionary associated with the transductive embedding module 404.

Next, at step 710, an inductive embedding technique is applied on the initial embeddings of the new managed object node and features of the new managed object node graph by the inductive embedding module 406 to generate final embeddings for the new managed object node. This inductive embedding generation can be performed in real time since retraining of the model used by the inductive embedding module 406 is not required. In an embodiment, the GraphSAGE algorithm is used by the inductive embedding module 406 to perform the inductive embedding technique. At step 712, the generated final embeddings are stored in the inductive dictionary by the inductive embedding module 406.

Next, at step 714, a link classification operation is executed on the final embeddings of the nodes of the ecosystem graph of the computing environment for the new managed object by the link classifier 408 to produce link scores for select guideline graph nodes that will be linked to the new managed object. Each link score for a guideline node corresponds to the strength of the link between the guideline node and the new managed object node. The final embeddings used are an updated version of previously generated final embeddings that are generated in response to the request for a guideline recommendation for the new managed object node.

Next, at step 716, a list of recommended guidelines for the new managed object based on the link scores of the select guideline graph nodes is generated by the link classifier 408. The list of recommended guidelines may be generated in a link score descending order such that the first recommended guideline is the guideline corresponding to the highest link score. In an embodiment, the link scores are presented with the recommended guidelines.

Next, at step 718, the list of recommended guidelines for the new managed object is displayed on the user interface as output. In an embodiment, the link scores are also displayed with the recommended guidelines. Using the output, one or more of these recommended guidelines may be manually entered or otherwise associated with the existing managed object by the user, i.e., an administrator. In other embodiments, one or more of these recommended guidelines may be automatically entered or otherwise associated by the guideline recommendation system 100.

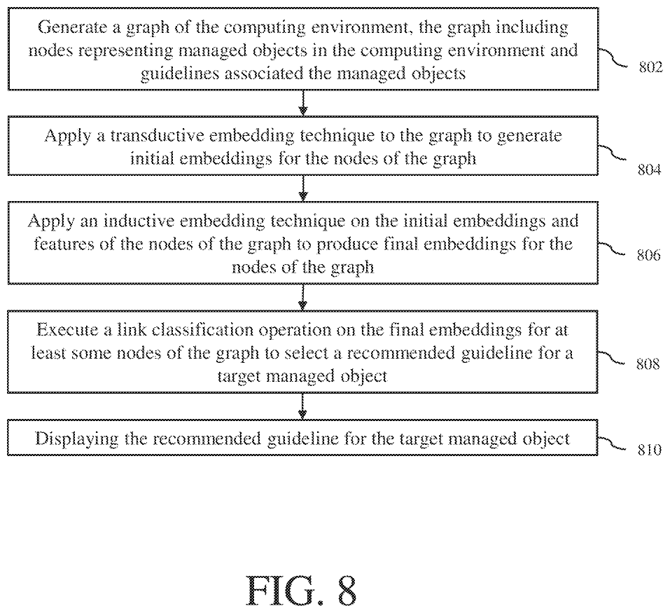

A computer-implemented method for recommending guidelines for managed objects for a computing environment in accordance with an embodiment of the invention is described with reference to a process flow diagram of FIG. 8. At block 802, a graph of the computing environment is generated. The graph includes nodes representing managed objects in the computing environment and guideline objects associated with the managed objects. At block 804, a transductive embedding technique is applied on the graph to generate initial embeddings for the nodes of the graph. At block 806, an inductive embedding technique is applied on the initial embeddings and features of the nodes of the graph to produce final embeddings for the nodes of the graph. At block 808, a link classification operation is executed on the final embeddings for at least some nodes of the graph to select a recommended guideline for a target managed object. At block 810, the recommended guideline for the target managed object is displayed.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer usable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for recommending guidelines for managed objects for a computing environment, the method comprising:
generating a graph of the computing environment, the graph including nodes representing managed objects in the computing environment and guideline objects associated the managed objects;
applying a transductive embedding technique on the graph to generate initial embeddings for the nodes of the graph;
applying an inductive embedding technique on the initial embeddings and features of the nodes of the graph to produce final embeddings for the nodes of the graph;
executing a link classification operation on the final embeddings for at least some nodes of the graph to select a recommended guideline for a target managed object; and
displaying the recommended guideline for the target managed object.

2. The computer-implemented method of claim 1, wherein the target managed object is an existing managed object in the computing environment and wherein the final embeddings are not an updated version of previously generated final embeddings that are generated in response to a request for a guideline recommendation for the existing managed object.

3. The computer-implemented method of claim 1, wherein the target managed object is a new managed object being added to the computing environment and wherein the final embeddings are an updated version of previously generated final embeddings that are generated in response to a request for a guideline recommendation for the new managed object.

4. The computer-implemented method of claim 3, wherein the updated version of previously generated final embedding is generated using a transductive embedding of a node corresponding to the new managed object and a node feature for the new managed object.

5. The computer-implemented method of claim 4, further comprising applying an incremental transductive embedding technique on the node corresponding to the new managed object to produce the transductive embedding for the new managed object.

6. The computer-implemented method of claim 5, wherein applying the incremental transductive embedding technique includes aggregating a mean of neighboring nodes of the new managed object, wherein a size of the neighboring nodes is predefined.

7. The computer-implemented method of claim 5, wherein applying the incremental transductive embedding technique includes producing random walks using the node of the new managed object and running a skip-gram model on the random walks.

8. The computer-implemented method of claim 1, wherein executing the link classification operation on the final embeddings includes producing link scores for select guideline nodes for the target managed object, and wherein each link score corresponds to a strength of link between a particular guideline node and the target managed object.

9. The computer-implemented method of claim 1, wherein the nodes of the graph represent a policy, a tag, a tag category, a data center, virtual machines, a folder, hosts and a cluster of hosts.

10. A non-transitory computer-readable storage medium containing program instructions for recommending guidelines for managed objects for a computing environment, wherein execution of the program instructions by one or more processors causes the one or more processors to perform steps comprising:
generating a graph of the computing environment, the graph including nodes representing managed objects in the computing environment and guideline objects associated the managed objects;
applying a transductive embedding technique on the graph to generate initial embeddings for the nodes of the graph;
applying an inductive embedding technique on the initial embeddings and features of the nodes of the graph to produce final embeddings for the nodes of the graph;
executing a link classification operation on the final embeddings for at least some nodes of the graph to select a recommended guideline for a target managed object; and
displaying the recommended guideline for the target managed object.

11. The non-transitory computer-readable storage medium of claim 10, wherein the target managed object is an existing managed object in the computing environment and wherein the final embeddings are not an updated version of previously generated final embeddings that are generated in response to a request for a guideline recommendation for the existing managed object.

12. The non-transitory computer-readable storage medium of claim 10, wherein the target managed object is a new managed object being added to the computing environment and wherein the final embeddings are an updated version of previously generated final embeddings that are generated in response to a request for a guideline recommendation for the new managed object.

13. The non-transitory computer-readable storage medium of claim 12, wherein the updated version of previously generated final embedding is generated using a transductive embedding of a node corresponding to the new managed object and a node feature for the new managed object.

14. The non-transitory computer-readable storage medium of claim 13, wherein the steps further comprise applying an incremental transductive embedding technique on the node corresponding to the new managed object to produce the transductive embedding for the new managed object.

15. The non-transitory computer-readable storage medium of claim 14, wherein applying the incremental transductive embedding technique includes aggregating a mean of neighboring nodes of the new managed object, wherein a size of the neighboring nodes is predefined.

16. The non-transitory computer-readable storage medium of claim 14, wherein applying the incremental transductive embedding technique includes producing random walks using the node of the new managed object and running a skip-gram model on the random walks.

17. The non-transitory computer-readable storage medium of claim 10, wherein executing the link classification operation on the final embeddings includes producing link scores for select guideline nodes for the target managed object, and wherein each link score corresponds to a strength of link between a particular guideline node and the target managed object.

18. The non-transitory computer-readable storage medium of claim 10, wherein the nodes of the graph represent a policy, a tag, a tag category, a data center, virtual machines, a folder, hosts and a cluster of hosts.

19. A system comprising:
memory; and
at least one processor configured to:
generate a graph of a computing environment, the graph including nodes representing managed objects in the computing environment and guideline objects associated the managed objects;
apply a transductive embedding technique on the graph to generate initial embeddings for the nodes of the graph;
apply an inductive embedding technique on the initial embeddings and features of the nodes of the graph to produce final embeddings for the nodes of the graph;
execute a link classification operation on the final embeddings for at least some nodes of the graph to select a recommended guideline for a target managed object; and
display the recommended guideline for the target managed object.

20. The system of claim 19, wherein the target managed object is a new managed object being added to the computing environment, wherein the final embeddings are an updated version of previously generated final embeddings that are generated in response to a request for a guideline recommendation for the new managed object, and wherein the updated version of previously generated final embedding is generated using a transductive embedding of a node corresponding to the new managed object and a node feature for the new managed object.
